(19) United States
(12) Patent Application Publication
(10) Pub. No.: US 2011/0019378 A1
(43) Pub. Date: Jan. 27, 2011

(54) COMPOSITE MICRO-CONTACTS

(75) Inventors: Russell S. Aoki, Tacoma, WA (US); Tod A. Byquist, Federal Way, WA (US)

Correspondence Address: Jordan IP Law, PC, c/o CPA Global, P.O. Box 52050, Minneapolis, MN, 55402, US

(73) Assignee: Tod A. Byquist, Federal Way, WA (US)

(21) Appl. No.: 12/509,735

(22) Filed: Jul. 27, 2009

(51) Int. Cl. H01R 9/00; H01R 13/40

(52) U.S. Cl. 361/776; 439/733.1

(57) ABSTRACT

Composite microelectronic contacts are provided in embodiments. These may include one or more arrays of isolated conductive tines coupled to and by isolation carriers. These carriers may serve to space the conductive tines apart and to couple the isolated tines together after the tines are no longer ganged together. The isolation carriers may comprise injection molded polymers as well as stamped materials. The isolation carriers may also contain locking tabs and recesses and seating plane stops.

### BACKGROUND

1. Technical Field

One or more embodiments provided herein relate to composite micro-contacts for electronic components. In particular, embodiments relate to composite micro-contacts having conductive tines and isolation carriers, where the tines may be used for carrying electrical signals, electrical power, or other electromagnetic waves, and where the isolation carriers may space or couple the tines.

2. Discussion

Electronic component packaging may enable electrical pathways between and/or through a silicon die, a package substrate, a socket body, and a circuit board. The connection between the silicon die and the package substrate may be referred to as a first-level interconnect while the connection between a socket body and the printed integrated circuit may be referred to as a second-level interconnect.

A silicon die may be connected to a package substrate through wires connecting the top of the silicon die to the package substrate. The package substrate may then be attached to the circuit board through elongated pins connected to and extending from the package substrate into a printed circuit board (PCB). This arrangement is sometimes referred to as a wire bond package. In some package configurations, balls of solder or other material may be used to connect the silicon die to the package substrate. These arrangements, which leave the top of the silicon die uncluttered and exposed, may allow a heat sink or other temperature control arrangement to reside on top of the silicon die because wires are not present on the top, as with the wire bond package. In this package, as with the wire bond package, pins extend from the package substrate into channels of a printed circuit board or other device to which the substrate is connected. This second arrangement is often called a flip-chip package.

Rather than use elongated pins extending into channels of the printed circuit board, solder balls may also be used to electrically connect the package substrate to the printed circuit board. These solder balls may be attached to the printed circuit board side of the flip-chip package and the wire bond package, and may be soldered to fixedly secure the package substrate to the printed circuit board, and to electrically connect the silicon die, through the substrate, to the printed circuit board.

### BRIEF DESCRIPTION OF THE DRAWINGS

The various advantages of the embodiments will become apparent by reading the specification and claims, and by referencing the following figures, in which:

FIG. 1 is a sectional view of an interconnect between a package substrate and composite micro-contacts, in accord with an embodiment;

FIG. 2 is the sectional view of the interconnect of FIG. 1 showing the package substrate in contact with the composite micro-contacts in accord with an embodiment;

FIG. 3A is an enlarged close up of a top view of two rows of composite micro-contacts in accord with an embodiment;

FIG. 3B is an enlarged close up of a bottom view of two rows of composite micro-contacts in accord with an embodiment;

FIG. 4 shows a perspective view of a gang of tines of composite micro-contacts, first without an isolation carrier, and then with an isolation carrier, in accord with an embodiment;

FIG. 5 is a perspective view of an array of composite micro-contacts atop a socket body as may be used in a printed circuit board in accord with an embodiment;

FIG. 6 is a perspective view of rows of composite micro-contacts being connected to form an array of composite micro-contacts in accord with an embodiment;

FIG. 7 is a perspective sectional view of a row of composite micro-contacts atop a printed circuit board in accord with an embodiment;

FIG. 8 is a bottom perspective view of a row of composite micro-contacts in accord with an embodiment;

FIG. 9 is a schematic top view of a printed circuit board in accord with an embodiment; and

FIG. 10 is a method employing composite micro-contacts in accord with an embodiment.

### DETAILED DESCRIPTION

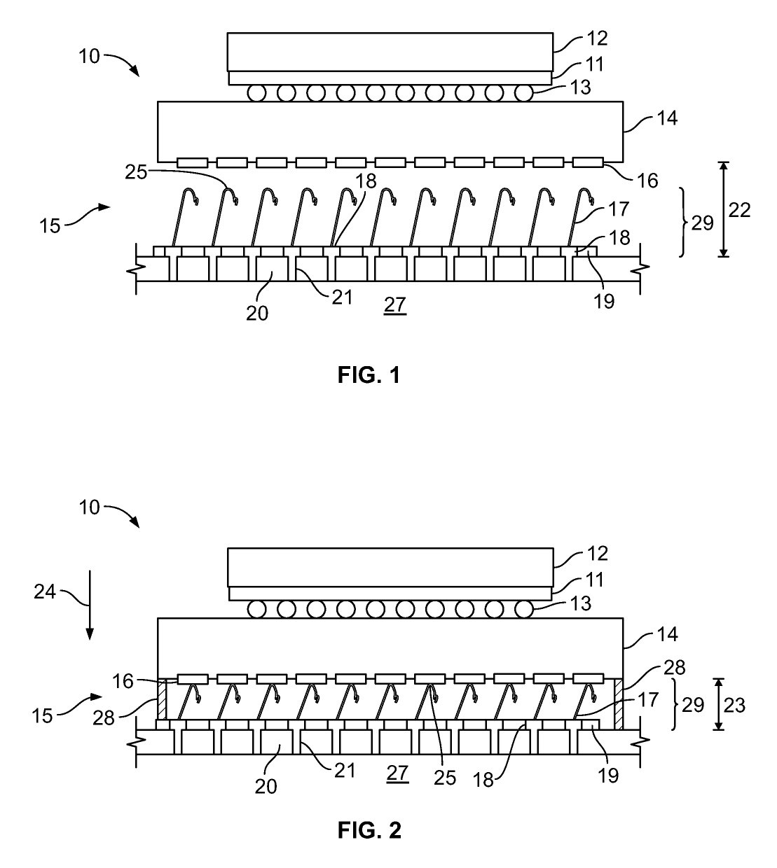

FIG. 1 shows an enlarged sectional view of a first interconnect 10 and second interconnect 15. The first interconnect may enable electrical signals to pass back and forth between the silicon die 12 and the package substrate 14. The second interconnect 15 may allow electrical signals to pass between the package substrate 14 and the socket body 20 or other component to which the composite micro-contacts are coupled. The composite micro-contacts 29 may be compressible such that as the package substrate 14 moves closer to the tine contacts 25, reaches them, and then compresses them further, the tines 17 may be in electrical connection with the pads 16, which are in turn in electrical connection with the silicon die 12. During the connection stroke, the tines 17 may move downward with little resistive force opposing the motion of the package substrate. As the tines 17 move downward, the position of the tine contact 25 for each tine 17, may move relative to the pad 16 that the contact 25 is touching. It is preferable, however, that the tine contact 25 does not move from one pad to the next while the tine is compressing, although embodiments may do so. In a final seated position, between the package substrate 14 and the socket body 20, or other component that the composite micro-contacts 29 are coupled to, the tines 17 may carry electrical signals and or electrical energy moving between the pads and the vias 21. The isolation carriers 19 between the tines 17 may serve as spacers for the tines 17 during assembly of the composite micro-contacts 29 or at other times as well.

For ease of reference, the labeled items in FIG. 1 are as follows: a silicon die 12, processed circuitry 11 of the silicon die 12, connector bumps 13 connecting the processed circuitry 11 and the package substrate 14, pads 16 on the bottom face of the package substrate 14, and composite micro-contacts 29, having tines 17, tine pads 18, tine contacts 25, and isolation carriers 19. Also visible are the socket body 20, vias 21, and printed circuit board 27.

In FIG. 1, the connector bumps 13 may be considered a first-level interconnect while the composite micro-contacts and the package pads 16 may be considered an intermediate-level interface. Also, the pads 16 arranged on the bottom of the package substrate 14 may be configured in an array and may be considered to be a land grid array contact system. Still further, an interposer may be placed below the composite micro-contacts 29 rather than a socket body. This interposer may serve to convert the pitch of the micro-contacts with the component that is coupled to the interposer.

Arrow 22 shows the distance between the isolation carriers 19 of the composite micro-contacts 29 and the package substrate 14. The tines 17 of the composite micro-contacts 29 may be used to couple or otherwise connect the pads 16 of the package substrate 14 with the vias 21 of the socket body 20. More generally speaking, the combination of package substrate 14, pads 16, and tines 17, may serve to connect the circuits of the silicon die 12 with the printed circuit board 27, and components connected to or in communication with the printed circuit board.

FIG. 2 shows the same microprocessor package and socket system of FIG. 1 except that in FIG. 2 the intermediate interconnect between the package substrate 14 and the socket body 20 is in a connected state. The arrow 23 shows how a gap between package substrate 14 and the tines 17 may be bridged and how the limits of this gap may be defined by a seating plane seat or stop 28. In this connected state, the substrate 14 may be held in place by the socket body 20 or by some other element and the distance between the socket body 20 and the substrate 14 may be limited by the seating plane seat or stop 28. The socket body 20 may be configured to allow the package substrate 14 to be released from the socket body 20 after a connection is made. Once the package substrate 14 is released from the socket body 20, it may move away from the socket body 20 in the direction opposite to the arrow 24. As the package substrate is urged down towards the socket body, there may be a step or seat of the body that offers resistance to signify that the package substrate is fully seated in the socket body or other resting position as may be the case in other embodiments. This resistance may be in addition to the seating plane seat or stop 28.

In embodiments there may be little or no force from the tines 17 opposing their compression against the pads 16 as the package substrate 14 moves into a seated position in the socket body 20. As described throughout, the micro-contacts 29 shown in FIGS. 1 and 2 may be used in numerous other configurations and applications as well as have different configurations in the assemblies and embodiments shown. This may include their relative length, the angle of bend, their spacing, the components connected by the composite micro-contacts, and other attributes as well.

The socket body 20 may be intended for use in various applications including desktop, server, and laptop applications as well PCBs or direct connection components. Thus, while first-level and intermediate-level interconnects are described, other connection scenarios may also use embodiments. The reduced thickness of the isolation carrier 19 may provide for lower profile intermediate-level interconnects. These lower profile interconnects may be used in tight height constraint designs, such as in laptop computers. Also, the spacing of the tines 17 may be increased or decreased to accommodate the specific socket body 20 or pads 16. The length of the tines 17 and vias 21 may also be reduced or otherwise adjusted to affect unwanted crosstalk between memory signals. Closer spaced tines 17 and vias 21 may provide for improved signal to ground ratios, which may in-turn may improve electrical performance. A preferred height of the composite microcontact may be 1.5 mm, although taller and shorter composite micro-contacts may also be used. A preferred spacing or pitch of the tines may be 0.65 mm although other spacings may also be used. This spacing may be consistent along a line of tines as well as across an entire array of them. The spacing may also vary between tines and in other ways as well. The height and the pitch of the tines may be adjusted or changed to provide for scalability of the composite micro-contacts. Also, as mentioned, a tight pitch of the composite micro-contacts may be interfaced with a larger pitched interposer to allow for conversion between micro-contacts and components of differing pitches.

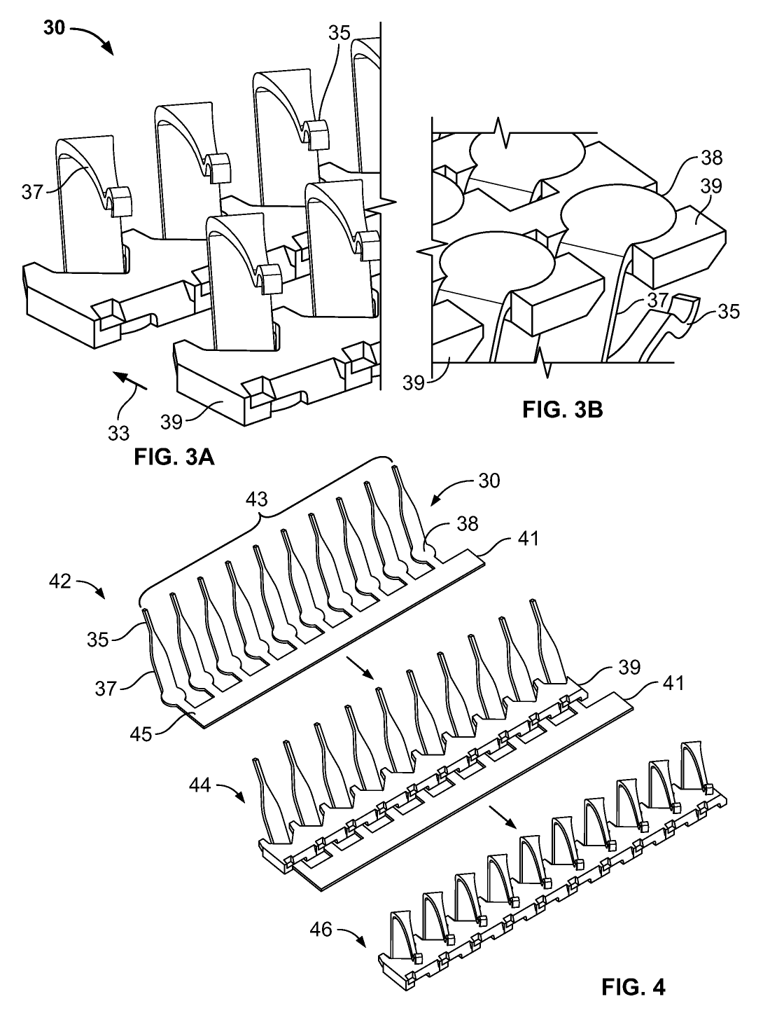

FIG. 3A shows an enlarged perspective view of exemplary composite micro-contacts 30 in accord with embodiments. The composite micro-contacts 30 of FIG. 3A are shown with tine contacts 35, tines 37, and isolation carriers 39. As can be seen, the isolation carriers 39 are sized to fit between the individual tines 37 and the isolation carriers may be mated with each other to form arrays of tines 37. The isolation carriers may comprise nonconductive material and may have various shapes and thicknesses as well as various tabs and recesses to facilitate assembly. The isolation carriers may be injection molded around the tines or prefabricated and then placed around the tines; other manufacturing and assembly methods may also be used to bring the tines and the isolation carrier 39 together. The isolation carriers 39 may serve to hold the tines 37 at a certain spacing and position before or after a tine connector connecting the tines is removed.

As can be seen in FIG. 3A, there are rows of tines 37 and isolation carriers 39 and these rows may be coupled together as shown by arrow 33. The isolation carriers 39 in this embodiment have been shaped to have mating components that may serve to align the tines and to hold the rows together. The tines 37 are shown in a compressed position with the tine contact 35 positioned at or below a high point in the bent tine 37. The specific application and component to be connected may serve to designate the angle of bend in the tine 37 and the location and configuration of the tine contact 35. This variability provides for scalability in certain embodiments.

FIG. 3B shows a bottom perspective view of the composite micro-contacts 30 from FIG. 3A, after the rows of tines 37 have been coupled together. As can be seen in FIG. 3B, an end of the tines 37 may be disk shaped or otherwise configured to provide a surface for making a physical electrical connection. This electrical connection may be for a first-level interconnect, an intermediate-level interconnect, a second-level interconnect, or other connection level. The tine pads 38 may be solder connected to a circuit board, to an interposer, or connected in various other ways to a circuit board, interposer or socket. The composite micro-contacts may be arranged in various patterns and the tines 37, isolation couplers 39, and tine pads 38, may be arranged in various configurations. It is preferred that each tine 37 be electrically isolated in this embodiment, however, pairs, groups, or combinations of tines may be connected to each other in other embodiments.

FIG. 4 shows an assembly sequence that may be used in accord with embodiments. Arrow 42 points to a set of ten tines 37 that are ganged together with temporary tine connector 41. This gang of tines 43 may be shaped as shown with the tines 37 being independent of each other and the temporary tine connector 41 serving to hold the tines 37 in a certain relationship with respect to each other. The tines 37 and the temporary tine connector 41 may be stamped from a single sheet of conductive material such as copper. Other materials may also be used, including, metals and composites. The temporary tine connector 41 may include a series of narrow elements 45 that facilitate easy separation of the temporary tine connector 41 from the tines 37.

Arrow 44 points to a set of ten tines 37 that are ganged with a temporary tine connector 41 and have been mated with an isolation carrier 39. As can be seen the isolation carrier 39 may reach across the entire set. The isolation carrier 39 may comprise an insulating material that helps to electrically isolate the individual tines once the temporary tine connector 41 is removed. The isolation carrier 39 may also serve to hold or secure the individual tines before and after the temporary tine connector 41 is removed. The isolation carrier may include alignment tabs, to assist in aligning more than one isolation coupler during assembly. The isolation carrier may also contain locking tabs or profiles that may serve to hold isolation carriers together. The isolation carrier may be injection molded around the tines and the temporary tine connector. Other manufacturing processes may be used as well for the stamping of the tines 37 and for the association of the ganged tines 43 and the isolation carrier 39.

Arrow 46 of FIG. 4 points to a set of tines 37 that are no longer ganged with a temporary tine connector 41 but are held and spaced by the isolation carrier 39. In embodiments, once the temporary tine connector 41 has been removed, the isolation carriers may be connected in various configurations to for various arrays or other arrangements of the tines 37. This is one of many possible scalable configurations of composite micro-contact embodiments.

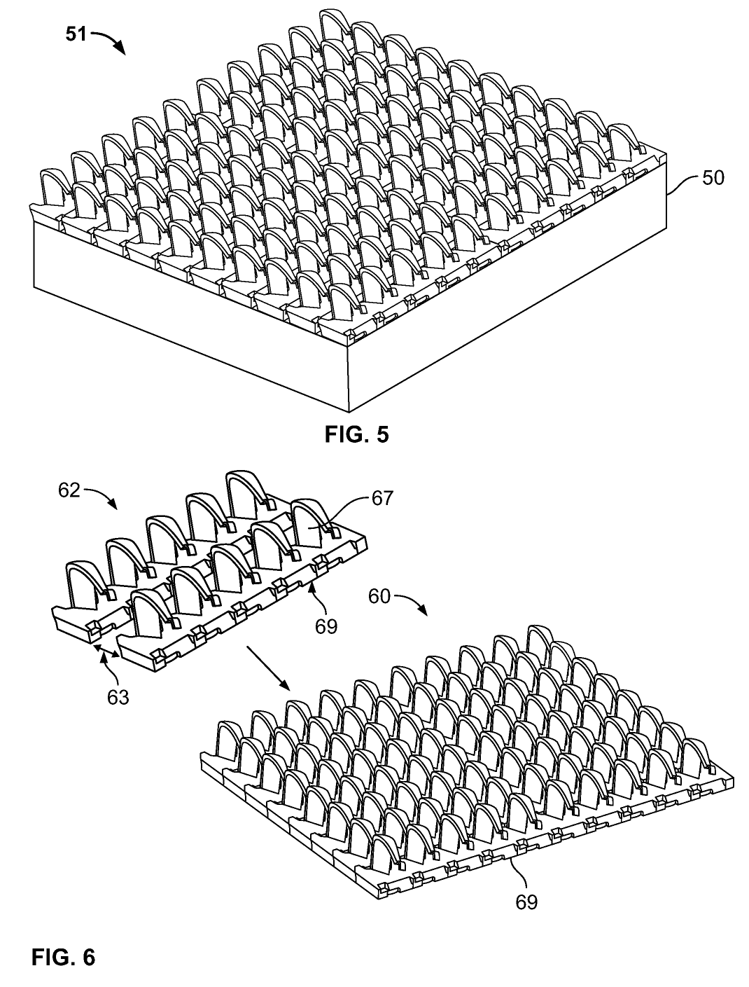

FIG. 5 shows an array of composite micro-contacts 51 atop an interposer or circuit board 50. The interposer or circuit board 50 is shown as a square and the composite micro-contacts are shown to conform to that square. In embodiments, other configuration of the interposer or circuit board 50 and the composite micro-contacts are possible. This includes the interposer or circuit board 50 having a shape different than the array of composite micro-contacts associated with the interposer or circuit board 50. The tine pads of the tines of FIG. 5, may be solder connected to vias in the interposer or circuit board. These vias may take signals or other electrical waves from the tines to other components connected through the vias.

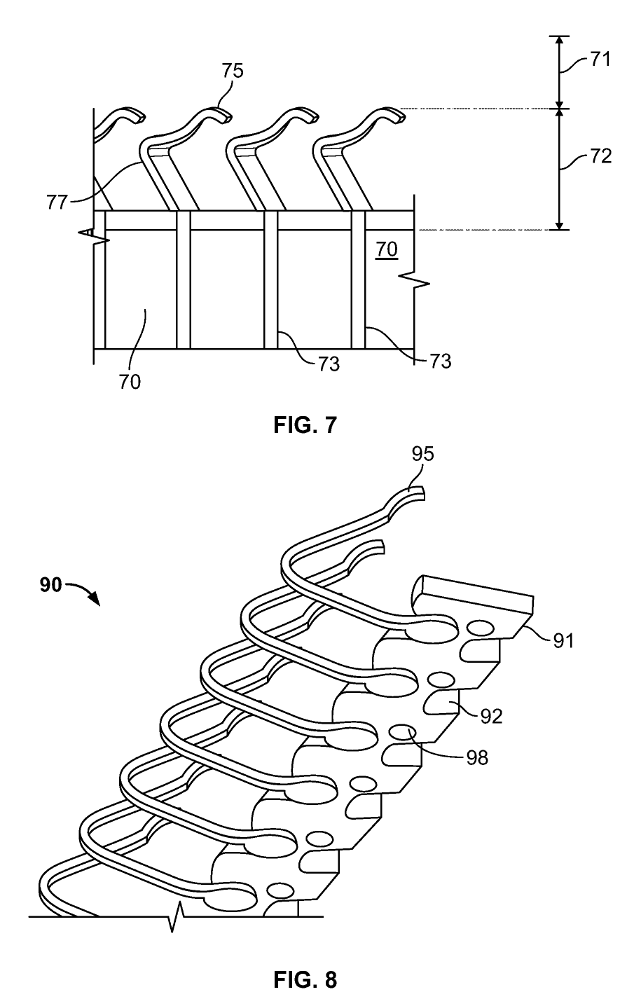

FIG. 6 shows how the composite micro-contacts 62 may be coupled together by aligning rows with one another. These aligned rows may for the shape of a square array 60. As noted above, other configurations may also be formed. Seating plane tabs may also located on the isolation carriers 69. These tabs may meet with other components to indicate that the composite micro-contacts have reached their fully seated contact position. The array 60 shown in FIG. 6 may be mounted to an interposer or directly to a PCB with solder balls. Other placements and mounting configurations may also be used.

FIG. 7 shows an enlarged perspective section of several composite micro-contacts atop a printed circuit board or interposer 70. The tines 77 are shown to be coupled to the vias 73 within the PCB 70. Signals or power reaching the tine contact 75 may flow through the tine 77 and the via 73 to reach components on the PCB. The tines 77 are shown in a compressed condition. Arrow 72 shows the height of the tines 77 after they have been compressed while arrow 71 shows the distance the tines 77 have been compressed. Distance 72 may be 1.5 mm. The tines may be configured to offer zero resistance when they are compressed the distance 71. The tines may be configured to offer some resistance in this range of travel as well. Seating plane tabs or indicators may lock in place or resist further compression of the tines 77, once the tines have been compressed the distance 71. The tines may be compressed the distance 71 when contacting pads of a package substrate the tines may be intended to electrically couple with. In embodiments, if the tines were compressed more than the distance of travel 71, the tines may begin to offer resistive force to further compression.

FIG. 8 shows a bottom perspective view of composite micro-contacts 90 in accord with embodiments. The isolation couplers of these micro-contacts 90 include stitching channels 91 as well as alignment recesses 92 and alignment tabs 98. The alignment recesses and tabs maybe used to associate the composite micro-contacts while the stitching channels 91 may be used to stitch the composite micro-contacts to a socket body or other component. This stitching may be used to make more permanent connection as well as a temporary connection. The stitching may be in addition to other methods for connecting the composite micro-contacts to each other or different components.

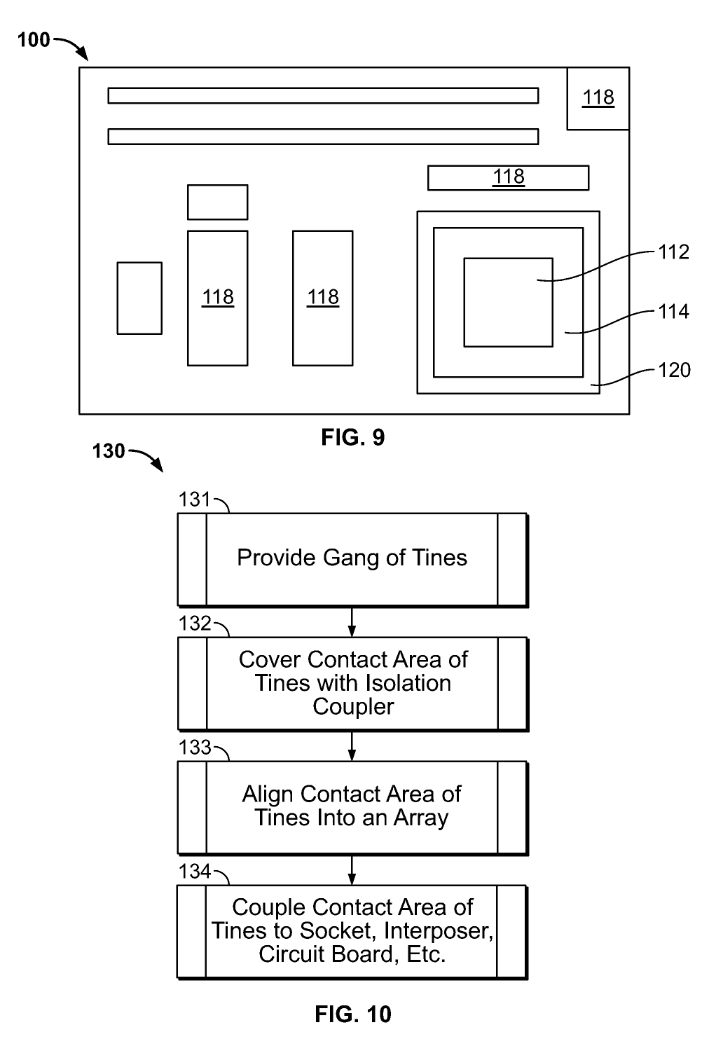

FIG. 9 shows a plan view of a printed circuit board that may employ the composite micro-contacts. The printed circuit board shown in this embodiment includes components 118, socket 120, package substrate 114 and silicon die 112. The arrangement on the PCB 100 may differ depending upon the embodiment. The composite micro-contacts described in the embodiments herein may be used to make connections between the package substrate 114 and the processor socket 120. The composite micro-contacts taught herein may also be used to make connections directly to the PCB and between other components as well.

FIG. 10 shows a method of an assembly or manufacturing embodiment. This method may include providing a gang of tines as noted by 131. The contact areas of these tines may be covered with an isolation carrier or coupler as noted by 132 and the contact areas may be aligned with one another as noted by 133. In addition, the method may also include coupling the contact area of the tines to vias or other components of the socket, PCB, or interposer as noted by 134. These actions may include further actions or different ones and may be performed in various orders depending upon the embodiment.

The terminology used herein is for the purpose of describing particular embodiments only and is not intended to be limiting. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

The description of the embodiments has been presented for purposes of illustration and description, but is not intended to be exhaustive or limited to the form disclosed. Many modifications and variations will be apparent to those of ordinary skill without departing from the scope and spirit of the disclosure. The embodiments were chosen and described in order to best explain the principles and the practical application, and to enable others of ordinary skill in the art to understand embodiments with various modifications as are suited to the particular use contemplated.

1. Composite microelectronic contacts comprising:
a first array of conductive tines,
one or more of the conductive tines of the first array having a first end and a second end, the first end having a contact area and the second end having a contact pad,
one or more of the tines in the first array of tines being bendable from a first position to a second position;
a first isolation carrier coupled to one or more conductive tines of the first array of conductive tines,
the first isolation carrier spacing conductive tines apart from one another,
the first isolation carrier electrically isolating one or more of the tines;
a second array of conductive tines,
one or more of the conductive tines of the second array of conductive tines having a first end and a second end, the first end having a contact area and the second end having a contact pad,
one or more of the tines in the second array of tines being bendable from a first position to a second position; and
a second isolation carrier coupled to one or more conductive tines of the second array of conductive tines,
the second isolation carrier spacing conductive tines apart from one another,
the second isolation carrier electrically isolating one or more of the tines,
the first isolation carrier being coupled to the second isolation carrier.

2. The composite microelectronic contacts of claim 1 having the first isolation carrier comprises tabs or recesses configured to mate with tabs or recesses of the second isolation carrier.

3. The composite microelectronic contacts of claim 1 having the first isolation carrier comprised of injection molded polymer.

4. The composite microelectronic contacts of claim 1 having at least the first isolation carrier or the second isolation carrier further comprising a seating plane tab.

5. The composite microelectronic contacts of claim 4 having the seating plane tab as a stop that retards further compression of tines.

6. The composite microelectronic contacts of claim 1 having one or more of the tines of the first array of conductive tines being electrically isolated from one or more other tines.

7. The composite microelectronic contacts of claim 6 with tines of the first array previously ganged together prior to being electrically isolated.

8. The composite microelectronic contacts of claim 1 having the first array of tines in a linear array and having the second array of tines in a linear array.

9. A system comprising:
a plurality of isolated bendable conductive tines; and
a nonconductive isolation carrier,
at least some tines positioned in an array,
at least some tines having an exposed contact pad and a tine contact,
at least some tines being held by the nonconductive isolation carrier,
at least some carrier surrounding at least a part of the exposed contact pad, and
at least some tines being bendable from a first position to a second position.

10. The system of claim 9 further comprising:
a package substrate having a land grid array of pads, the pads in contact with one or more of the plurality of isolated bendable conductive tines.

11. The system of claim 9 further comprising:
an interposer or printed circuit board, the interposer or printed circuit board containing a plurality of vias, at least some of the vias arranged to connect with the exposed contact pads of the plurality of tines.

12. The system of claim 9 further comprising:
a package substrate having a land grid array of pads; and
a socket body, the socket body containing a plurality of vias,
the package substrate, the socket body or both contain a seating plane tab.

13. The system of claim 11 with the socket body positioned atop a printed circuit board.

14. The system of claim 9 with the tines bendable in a first range of motion that offers substantially zero resistance to bending.

15. The system of claim 13 with the height of the tines above the printed circuit board is substantially 1.5 mm or less.

16. A printed circuit board comprising:
a silicon die;
a package substrate interconnected with the silicon die; and
a processor socket, the processor socket interconnected with the package substrate,
the interconnect between the processor socket and the package substrate including:
an array of isolated conductive tines, the tines in contact with an exposed land grid array of the package substrate, the tines bendable from a first position to a second position,
an isolation carrier spacing the tines apart from each other, the isolation carrier comprising a nonconductive material, the isolation carrier previously positioned about a gang of tines forming the array of isolated conductive tines.

17. The printed circuit board of claim 16, the isolation carrier comprising an injection molded polymer.

18. The printed circuit board of claim 16, having the isolation carrier comprising a plurality of form fitting pieces that use mechanical connections to connect to each other.

19. The printed circuit board of claim 18, having the form fitting pieces stamped during manufacture.

20. The printed circuit board of claim 17, having a plurality of linear arrays comprising the isolation carrier.
